(19) United States
(12) Patent Application Publication
(10) Pub. No.: US 2011/0038672 A1
(43) Pub. Date: Feb. 17, 2011

(54) SYSTEM AND METHODS TO INSTALL SUBSEA STRUCTURES

(76) Inventor: Christopher Steven West, Pearland, TX (US)

Correspondence Address: SHELL OIL COMPANY, P O BOX 2463, HOUSTON, TX, 772522463, US

(21) Appl. No.: 12/600,121

(22) PCT Filed: May 15, 2008
(86) PCT No.: PCT/US08/63731

§ 371 Date: Nov. 5, 2010

Related U.S. Application Data
(60) Provisional application No. 60/938,336, filed on May 16, 2007.

(51) Int. Cl. B63B 35/03; F16L 1/12

(52) U.S. Cl. 405/166; 405/154.1

(57) ABSTRACT

A system comprising a structure defining an interior of the system; an apparatus exterior to the structure, the apparatus adapted to reduce in size when lowered into a body of water; a strap exterior to the apparatus, the strap adapted to reduce in size as the apparatus reduces in size.

### FIELD OF INVENTION

The present disclosure relates to systems and methods for installing structures in a body of water.

### BACKGROUND

Structures can be installed at sea from a floating vessel using either a J-lay configuration where the structure is held vertically on the vessel and dropped vertically into the water and then when it reaches the bottom of the body of water, it lays horizontal, or structures can be installed in a S-lay configuration where the structure is held horizontally on the vessel, drops to the vertical through the body of water, and then rests on the bottom of the body of water in a horizontal configuration. Other configurations for installing a structure from a vessel in a body of water are also known.

Referring now to FIG. 1, a view of a prior art system 100 for installing a structure 114 in body of water 112 is illustrated. System 100 includes vessel 110 with tensioner 120 which is holding structure 114. Structure 114 is being installed on the bottom 116 of body of water 112. Vessel 110 and tensioner 120 keep structure in a vertical configuration when entering the water, and if tensioner 120 were to fail or if vessel 110 to sink, structure 114 would sink to the bottom 116. Vessel 110 and tensioner 120 must have a sufficient capacity to support structure 114 so that it can be installed on bottom 116 in a desired manner.

Referring now to FIG. 2, prior art system 200 for installing structure 214 on bottom 216 of body of water 212 is illustrated. System 200 includes vessel 210 with tensioner 220 and stinger 218. Tensioner 220 holds structure 214 in a horizontal configuration as it enters water, and then structure 214 drops to a vertical configuration, and then back to a horizontal configuration as it lays on bottom 216. Tensioner 220 and vessel 210 must have a sufficient capacity to support structure 214 as it is being installed.

It can be seen from FIGS. 1 and 2 that as the weight of structures 114 and 214 increases, and as the depth of water 112 and 212 increase, there is a need for an increased capacity of vessels 110 and 210 and tensioners 120 and 220.

In order to increase the buoyancy of subsea structures and/or to insulate the structure from the ambient water temperature, a foam may be applied to the exterior. Generally, a polyolefin foam, for example, polyethylene may be used in depths up to about 100 meters for buoyancy or insulation applications. A polyurethane foam may also be used in depths up to about 100 meters. Co-polymer foams can be used at depths up to 600 or even up to 1000 meters.

Syntactic foams are used for installation and buoyancy applications in deeper waters. Syntactic foams are manufactured by placing microspheres of hollow glass or other materials in a polymer matrix. Syntactic foams can be used at depths up to 3000 meters, up to 4000 meters, or more.

Generally, foams are compressed as they are lowered into water and the ambient pressure increases. Structures that are installed exterior to the foam may fit around the foam perfectly at the surface, but when the foam shrinks in the water, a gap appears between the structure and the foam.

U.S. Pat. No. 7,195,530 discloses a system comprising a structure in a body of water, wherein the body of water comprises a depth comprising a top-section from a surface of the body of water to one-third of the depth, and a second-section from one-third of the depth to two-thirds of the depth, a first buoyant apparatus attached to the structure in the top-section of the depth, a second buoyant apparatus attached to the structure in the second-section of the depth, wherein the second buoyant apparatus provides a second buoyancy effect average per length of the structure at least 30% less than a first buoyancy effect average per length of the structure provided by the first buoyant apparatus. U.S. Pat. No. 7,195,530 is herein incorporated by reference in its entirety.

There is a need in the art for systems and/or methods to efficiently install structures in a body of water.

There is a need in the art for systems and/or methods to compensate for the shrinkage of foam on the exterior of a structure.

### SUMMARY OF THE INVENTION

One aspect of the invention includes a system comprising a structure defining an interior of the system; an apparatus exterior to the structure, the apparatus adapted to reduce in size when lowered into a body of water; a strap exterior to the apparatus, the strap adapted to reduce in size as the apparatus reduces in size.

Another aspect of the invention includes a method of installing a structure in a body of water comprising attaching an apparatus exterior to the structure; attaching a strap exterior to the apparatus, the strap comprising a mechanism adapted to keep a tension on the strap; lowering the apparatus and strap into the body of water; and wherein the apparatus has a reduction in volume due to an ambient water pressure in the body of water, and the strap has a corresponding reduction in length to compensate for the apparatus reduction in volume.

Advantages of the invention include one or more of the following:

Systems and/or methods to more efficiently install structures in a body of water; and/or

Systems and/or methods to compensate for the shrinkage of foam on the exterior of a structure.

### BRIEF DESCRIPTION OF THE DRAWINGS

FIG. 1 illustrates a prior art system for installing a structure in a body of water in a J-lay configuration.

FIG. 2 illustrates a prior art system for installing a structure in a body of water in an S-lay configuration.

FIG. 3 illustrates a system for installing a structure in a body of water.

FIG. 4 illustrates a cross-sectional end view of a section of a structure.

FIG. 5 illustrates a side view of a section of a structure.

FIG. 6 illustrates two adjacent sections of a structure connected to each other.

FIG. 7 illustrates a cross-sectional end view of a section of a structure.

FIG. 8 illustrates the effects of pressure on a foam.

FIGS. 9a-9b illustrate a cross-sectional end view of a section of a structure.

FIGS. 10a-10b illustrate a cross-sectional end view of a section of a structure.

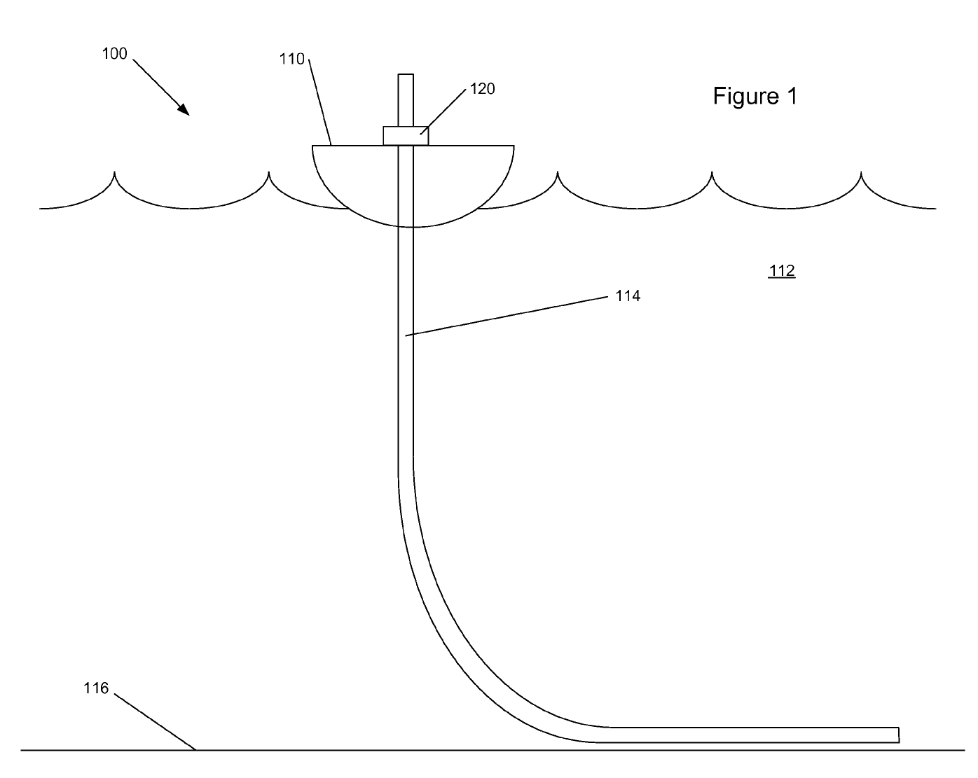

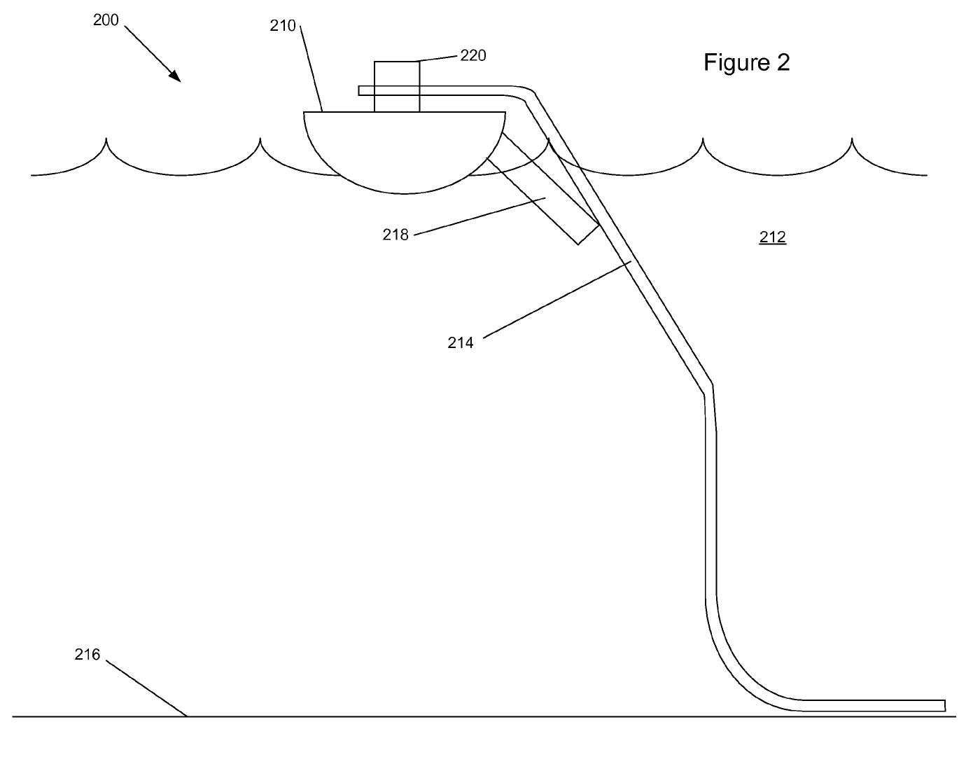

### DETAILED DESCRIPTION OF THE INVENTION

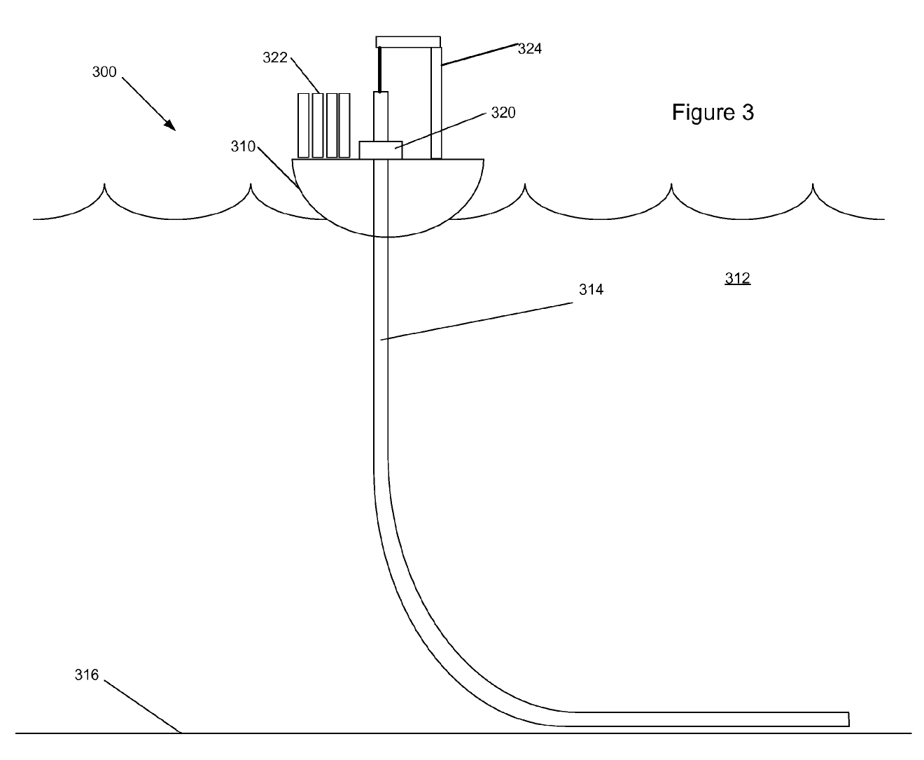

Referring now to FIG. 3, system 300 is illustrated. System 300 includes vessel 310 in body of water 312, installing structure 314 in body of water 312 and resting a portion of structure 314 on bottom 316. Vessel 310 may include tensioner 320 to keep tension on structure 314 so that it does not sink in water 312. Lift 324 may be used to place sections 322 on top of existing structures 314, where sections 322 may be welded, or threaded, or otherwise attached, to existing structure 314.

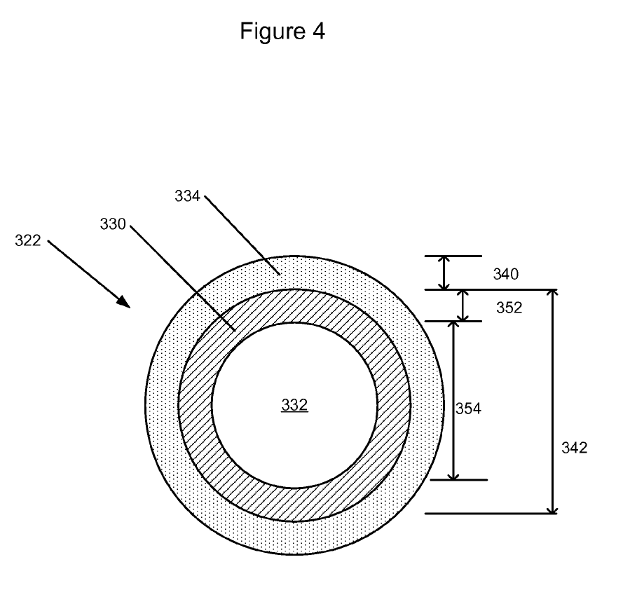

Referring now to FIG. 4, section 322 is illustrated. Section 322 may include pipe 330 defining passage 332. Foam 334 is about a circumference of pipe 330. Foam 334 may have thickness 340. Pipe 330 may have inside diameter 354, outside diameter 342, and wall thickness 352.

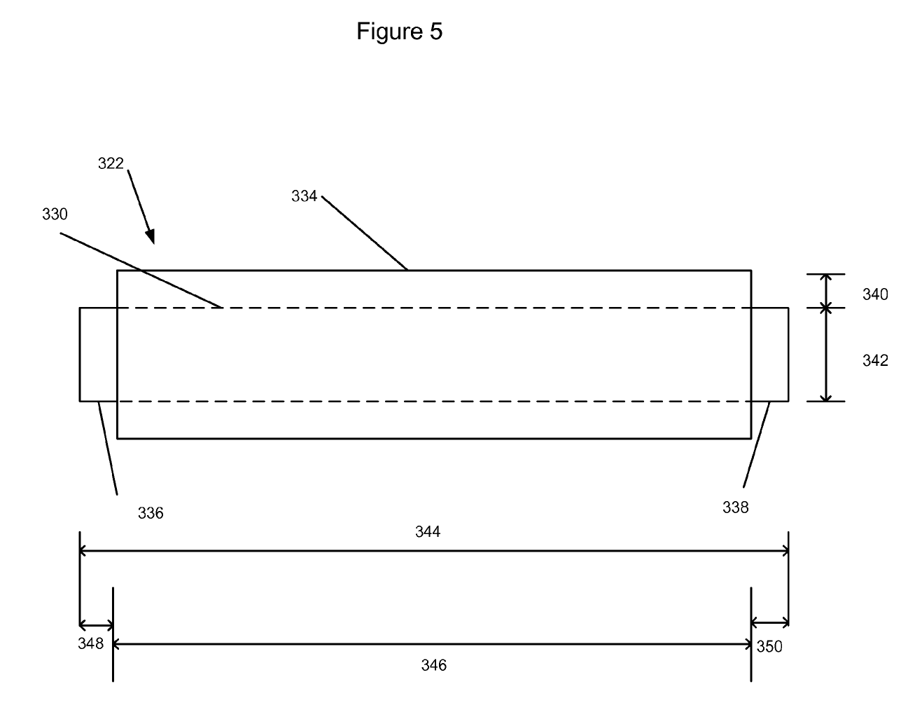

Referring now to FIG. 5, section 322 is illustrated. Section 322 may include pipe 330 having foam 334 about its circumference for foam length 346. Pipe length 344 may be longer than foam length 346 leaving exposed first pipe end 336 and second pipe end 338. First pipe end 336 has end length 348, and second pipe end 338 has end length 350. Pipe 330 has diameter 342, and foam 334 has thickness 340.

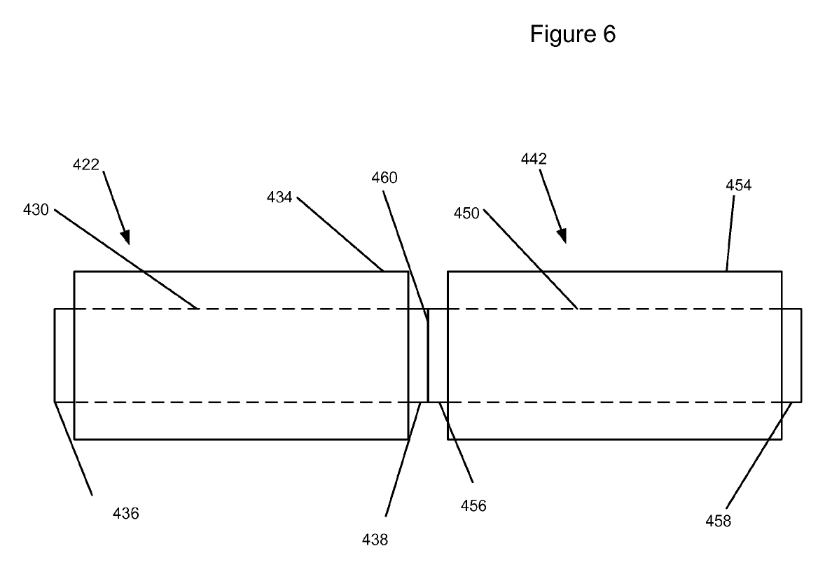

Referring now to FIG. 6, section 422 may be connected to section 442. Section 422 has pipe 430 with foam 434 about its exterior, with first pipe end 436 and second pipe end 438. Section 442 has pipe 450 with foam 454 about its exterior, with first pipe end 456 and second pipe end 458. To attach section 422 to section 442, second pipe end 438 may be aligned with first pipe end 456, and then a connection 460 may be made between section 422 and section 442, for example, a weld, a threaded connection, or another suitable mechanical connection.

In some embodiments, section 322 may include passage 332 defining an interior of section 322, with pipe 330 exterior to passage 332, and foam 334 exterior to pipe 330 and passage 332. In some embodiments, section 322 also may include skin, shell, or second pipe exterior to foam 334, pipe 330, and passage 332. Foam 334, may be a polyolefin foam, polyethylene foam, polyurethane foam, a copolymer foam, or any other suitable foam having a density less than water to provide a buoyancy effect to section 322, or may be an insulating foam which could have a density greater than water. Skin, shell, or second pipe may be any suitable material, for example, same material as foam 334, or a different material which provides more structural integrity and/or strength to foam 334.

In some embodiments, foam 334 has a density less than about 500 kilograms per meter cubed, or less than about 250 kilograms per meter cubed, or less than about 100 kilograms per meter cubed, or less than about 75 kilograms per meter cubed.

In some embodiments, foam 334 may be manufactured from a base material having a density less than water.

Suitable foams and/or methods of manufacturing foams and/or extruding foams are disclosed in WO 00/75546; U.S. Pat. No. 3,121,130; U.S. Pat. No. 4,119,122; and/or US publication number 2004/0003856, the entire disclosures of which are herein incorporated by reference in their entirety.

In operation, vessel 310 may be in water 312, with sections 322, on board. Each section 322 may include pipe 330 and foam 334 about its exterior, with an optional skin, or exterior pipe to increase the strength of foam 334. Each section 334 may be lifted by lift 324, and feed through tensioner 320. As structure 314 is lowered by tensioner 320, a section may be lifted, and then attached to existing structure 314. Additional sections are attached and lowered until structure 314 has desired length. In some embodiments, structure 314 may be lowered onto bottom 316 of water 312. In some embodiments, water 312 has a depth of at least about 1000 meters, at least about 2000 meters, at least about 3000 meters, or at least about 4000 meters. In some embodiments, water 312 has a depth up to about 10,000 meters.

In some embodiments of the invention, structure 314 may be a pipeline, a crude oil flowline, a mooring line, a riser, a tubular, or any other structure installed in a body of water. In some embodiments, structure 314 may have a diameter of about 0.1 to about 5 meters, and a length of about 1 to about 200 kilometers (km). In some embodiments, structure 314 may have a length to diameter ratio of about 100 to about 100,000, or about 100,000 to 10,000,000 or larger. In some embodiments, structure 314 may be composed of about 50 to about 30,000 tubular sections, each with a diameter of about 10 cm to about 150 cm and a length of about 5 m to about 75 m, and a wall thickness of about 0.5 cm to about 5 cm.

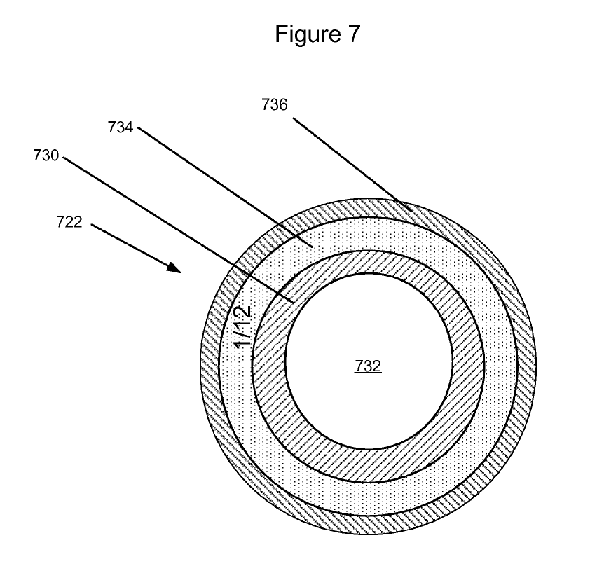

Referring now to FIG. 7, section 722 is illustrated. Section 722 may include pipe 730 defining passage 732. Foam 734 may be about a circumference of pipe 730. Foam support structure 736 may be about a circumference of foam 734. In some embodiments, foam support structure 736 may be a polymer skin, a polymer or metal pipe, a coating, or another suitable structure to protect foam 734.

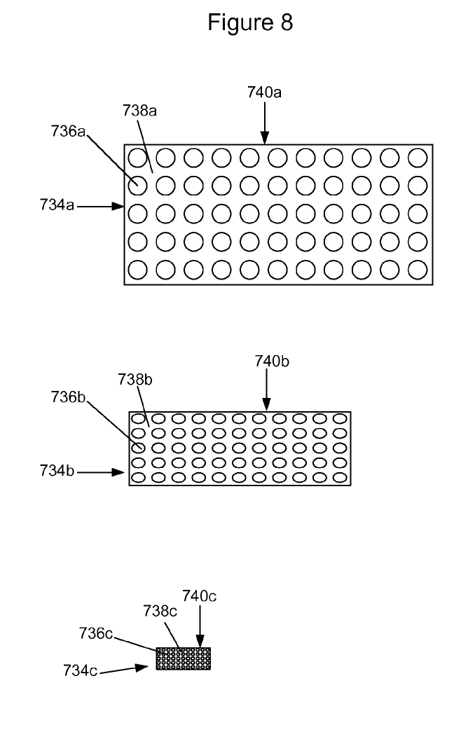

Referring now to FIG. 8, in some embodiments, foam is illustrated. Foam 734a includes closed cells 736a in a matrix 738a. Cells 736a may include a trapped gas, for example air. Matrix 738a may be a polymer, for example a polyolefin, such as polyethylene or polypropylene, or polyurethane. Pressure 740a is acting on foam 734a.

In some embodiments, pressure 740b is greater than pressure 740a, and is acting on foam 734b. Foam 734b includes closed cells 736b in a matrix 738b. Pressure 734b compresses foam 734b to a reduced volume and/or bursts cells 736b, which may cause foam 734b to have a higher density and/or a reduced buoyancy effect compared to foam 734a.

In some embodiments, pressure 740c is greater than pressure 740a and 740b, and is acting on foam 734c. Foam 734c includes closed cells 736c in a matrix 738c. Pressure 740c compresses foam 734c to a reduced volume and/or bursts cells 736c, which may cause foam 734c to have a higher density and/or a reduced buoyancy effect compared to foams 734a and 734b.

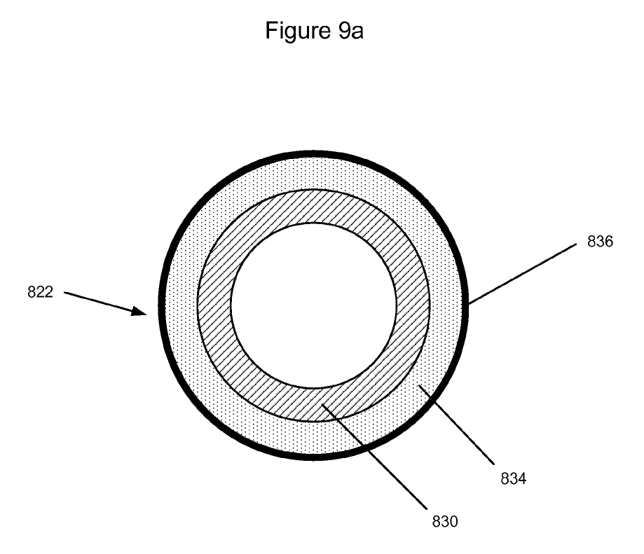

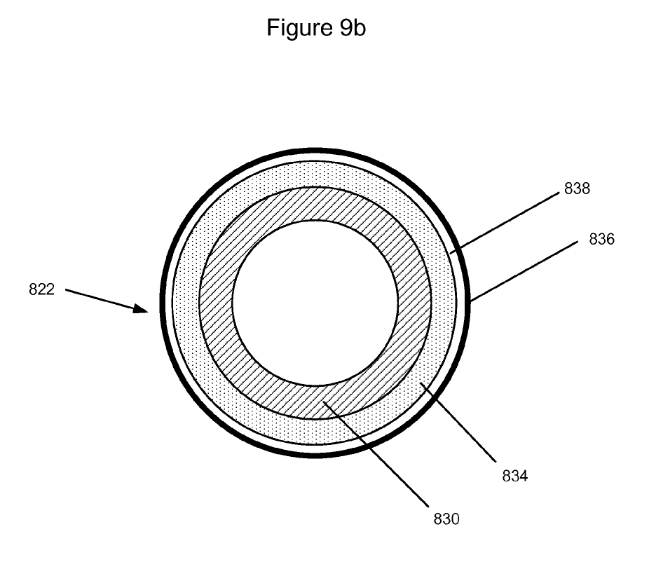

Referring now to FIG. 9a, section 822 is illustrated. Section 822 may include pipe 830 defining a passage. Foam 834 may be about a circumference of pipe 830. Strap 836 may be about a circumference of foam 834. In some embodiments, strap 836 may be a ring, a collar, a band, or another suitable device installed exterior to foam 834.

Referring now to FIG. 9b, section 822 is illustrated. Section 822 is the same section as in FIG. 9a, which has now been lowered into a body of water to compress foam 834. Compressed foam 834 creates gap 838 between foam 834 and strap 836. Gap 838 may allow strap to be disconnected from foam 834, rotate about foam 834, and/or move along the length of foam 834.

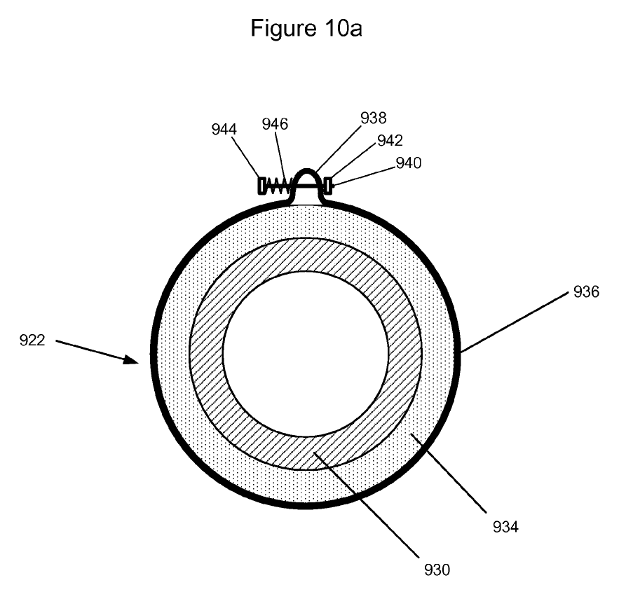

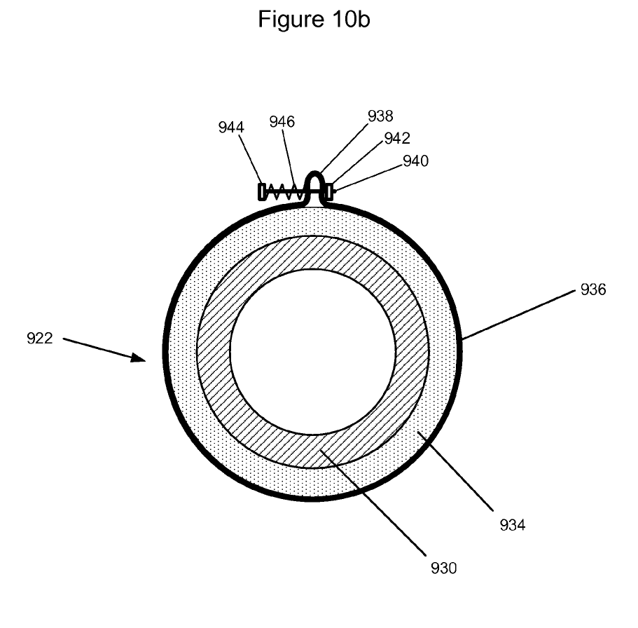

Referring now to FIG. 10a, section 922 is illustrated. Section 922 may include pipe 930 defining a passage. Foam 934 may be about a circumference of pipe 930. Strap 936 may be about a circumference of foam 934. In some embodiments, strap 936 may be a ring, a collar, a band, or another suitable device installed exterior to foam 934. Strap 936 includes loop portion 938. Connector 940 is fed through loop portion 938 with end piece 942 and end piece 944. One or more biasing means 946 are provided between end piece 944 and loop portion 938, which acts to squeeze loop portion 938 together and keep tension on strap 936. Another biasing means (not shown) may be provided between end piece 942 and loop portion 938.

Referring now to FIG. 10b, section 922 is illustrated. Section 922 is the same section as in FIG. 10a, which has now been lowered into a body of water to compress foam 934. Instead of forming a gap as shown in FIG. 9b, biasing means 946 squeezed loop portion 938 together, and reduced the circumference of strap 936, to keep strap 936 adjacent to foam 934.

In one embodiment, there is disclosed a system comprising a structure defining an interior of the system; an apparatus exterior to the structure, the apparatus adapted to reduce in size when lowered into a body of water; a strap exterior to the apparatus, the strap adapted to reduce in size as the apparatus reduces in size. In some embodiments, the structure is in a body of water, further comprising a vessel connected to the structure, wherein the vessel is floating in the body of water. In some embodiments, the structure is selected from the group consisting of an oil flowline, a pipeline, a riser, and a steel tubular. In some embodiments, the apparatus comprises a polymeric foam. In some embodiments, the system also includes a polymeric skin exterior to the foam. In some embodiments, the structure comprises a plurality of sections welded to each other. In some embodiments, the structure comprises a plurality of sections threaded to each other. In some embodiments, the apparatus comprises foam having a thickness of at least 10 cm. In some embodiments, the strap comprises a biasing mechanism adapted to keep a tension on the strap. In some embodiments, the strap comprises a loop portion adapted to be squeezed together by a biasing mechanism to keep a tension on the strap.

In one embodiment, there is disclosed a method of installing a structure in a body of water comprising attaching an apparatus exterior to the structure; attaching a strap exterior to the apparatus, the strap comprising a mechanism adapted to keep a tension on the strap; lowering the apparatus and strap into the body of water; and wherein the apparatus has a reduction in volume due to an ambient water pressure in the body of water, and the strap has a corresponding reduction in length to compensate for the apparatus reduction in volume. In some embodiments, the reduction in volume of the apparatus is at least about 0.1%. In some embodiments, the reduction in volume of the apparatus is at least about 0.5%. In some embodiments, the reduction in volume of the apparatus is at least about 1%. In some embodiments, the reduction in length of the strap is at least about 0.1%. In some embodiments, the reduction in length of the strap is at least about 0.5%. In some embodiments, the reduction in length of the strap is at least about 1%. In some embodiments, the method also includes a skin or a pipe exterior to the apparatus, the skin adapted to provide additional strength to the apparatus. In some embodiments, at least a portion of the structure rests on a bottom of the body of water.

Those of skill in the art will appreciate that many modifications and variations are possible in terms of the disclosed embodiments, configurations, materials and methods without departing from their spirit and scope. Accordingly, the scope of the claims appended hereafter and their functional equivalents should not be limited by particular embodiments described and illustrated herein, as these are merely exemplary in nature.

1. A system comprising:
a structure defining an interior of the system;
an apparatus exterior to the structure, the apparatus adapted to reduce in size when lowered into a body of water;
a strap exterior to the apparatus, the strap adapted to reduce in size as the apparatus reduces in size.

2. The system of claim 1, wherein the structure is in a body of water, further comprising a vessel connected to the structure, wherein the vessel is floating in the body of water.

3. The system of claim 1, wherein the structure is selected from the group consisting of an oil or gas flowline, an oil or gas export line, a pipeline, a riser, and a steel tubular.

4. The system of claim 1, wherein the apparatus comprises a polymeric foam.

5. The system of claim 4, further comprising a polymeric skin exterior to the foam.

6. The system of claim 1, wherein the structure comprises a plurality of sections welded to each other.

7. The system of claim 1, wherein the structure comprises a plurality of sections threaded and/or clamped to each other.

8. The system of claim 1, wherein the apparatus comprises foam having a thickness of at least 10 cm.

9. The system of claim 1, wherein the strap comprises a biasing mechanism adapted to keep a tension on the strap.

10. The system of claim 1, wherein the strap comprises a loop portion adapted to be squeezed together by a biasing mechanism to keep a tension on the strap.

11. A method of installing a structure in a body of water comprising:
attaching an apparatus exterior to the structure;
attaching a strap exterior to the apparatus, the strap comprising a mechanism adapted to keep a tension on the strap;
lowering the apparatus and strap into the body of water; and
wherein the apparatus has a reduction in volume due to an ambient water pressure in the body of water, and the strap has a corresponding reduction in length to compensate for the apparatus reduction in volume.

12. The method of claim 11, wherein the reduction in volume of the apparatus is at least about 0.1%.

13. The method of claim 11, wherein the reduction in volume of the apparatus is at least about 0.5%.

14. The method of claim 11, wherein the reduction in volume of the apparatus is at least about 1%.

15. The method of claim 11, wherein the reduction in length of the strap is at least about 0.1%.

16. The method of claim 11, wherein the reduction in length of the strap is at least about 0.5%.

17. The method of claim 11, wherein the reduction in length of the strap is at least about 1%.

18. The method of claim 11, further comprising a skin or a pipe exterior to the apparatus, the skin adapted to provide additional strength to the apparatus.

19. The method of claim 11, wherein at least a portion of the structure rests on a bottom of the body of water.

20. The method of claim 11, wherein the strap is adapted to hold the apparatus about the structure.

21. The method of claim 11, wherein the apparatus comprises one or more foam modules.

22. The method of claim 11, wherein the strap is adapted to hold a second apparatus about the apparatus and the structure.

23. The method of claim 22, wherein the second apparatus comprises a vortex induced vibration and/or drag suppression device, for example a strake or a fairing.
